(19) United States
(12) Patent Application Publication
(10) Pub. No.: US 2009/0039070 A1
(43) Pub. Date: Feb. 12, 2009

(54) SEMICONDUCTOR EQUIPMENT AND BREAKDOWN PRECAUTIONARY SYSTEM AND METHOD THEREOF

(76) Inventors: Jung-Wen Tseng, Hsinchu County (TW); Ching-Yuan Chen, Hsinchu City (TW); Cheng-Chung Hung, Tainan County (TW)

Correspondence Address: NORTH AMERICA INTELLECTUAL PROPERTY CORPORATION, P.O. BOX 506, MERRIFIELD, VA, 22116, US

(21) Appl. No.: 11/834,618

(22) Filed: Aug. 6, 2007

(51) Int. Cl. F27B 1/09; G08B 21/18

(52) U.S. Cl. 219/412; 219/392; 219/408; 219/411; 340/663; 340/664; 361/79

(57) ABSTRACT

A breakdown precautionary system of a semiconductor equipment includes a semiconductor equipment with a coil heater, at least a voltage/current detector, and an alarm system. The voltage/current detector detects the voltage and current of the coil heater at the same time. An alarm system will send an alarm signal and initiate an interlock safety measure of the semiconductor equipment when the detected current of the coil heater is 0 ampere.

### BACKGROUND OF THE INVENTION

1. Field of the Invention

The present invention is related to a breakdown precautionary system and method of a semiconductor equipment, and more particularly, to a breakdown precautionary system and method of a semiconductor equipment by detecting the voltage and current of the heater of the semiconductor equipment for monitoring the performance of the heater.

2. Description of the Prior Art

In the semiconductor process, a plurality of thin films are formed on a semiconductor wafer and undergo several process, such as photolithography and etching processes, for manufacturing the predetermined circuit patterns of the integrated circuit (IC), which means the predetermined connection and separation portions of the IC are developed in the thin films on the semiconductor wafer.

Generally, the formation method of a thin film on the semiconductor wafer contains deposition and growth processes. The common deposition process comprises chemical vapor deposition (CVD) and physical vapor deposition (PVD) processes, and the common growth process comprises oxidation process. For example, the theory of oxidation process comprises exposing the silicon wafer (or semiconductor wafer) under an oxygen-rich environment with a high temperature such that the oxygen molecules react with the silicon atoms on the surface of the silicon wafer to form a silicon dioxide thin film, and the oxygen molecules may further diffuse in the silicon dioxide thin film under a thermal diffusion effect to reach the surface of the silicon wafer below the formed silicon dioxide thin film and continue reacting with the silicon atoms so that the silicon dioxide thin film keeps on growing. Since the oxidation process has to be carried out in an environment with high temperature, a furnace is used as a traditional equipment of the oxidation process.

Furnace could be divided into a horizontal type furnace and a vertical type furnace. The vertical type furnace contains the following advantages: the occupation space of the vertical type furnace in a clean room is small; less contamination particles are found in the vertical type furnace; a thin film with an uniform thickness can be formed because the wafers or cassette can be rotated horizontally; and the wafers can be loaded and unloaded by a robot-arm automatically. Therefore, the heating processes of wafers with a size of 8 inches or above are mostly carried out in the vertical type furnace for meeting the strict standard and requirement of semiconductor fabrication. Referring to FIG. 1, FIG. 1 is a schematic diagram of the structure of a vertical type furnace 10 according to the prior art. The prior-art vertical type furnace 10 comprises a quartz tube 12, a coil heater 14, an air control system 16, a source cabinet 18, a control computer 20, a temperature control system 22, and a bottom cover 24. The vertical type furnace 10 may further comprises a cooling water device and an automatic wafer transfer device (not shown), wherein the cooling water device helps to control the temperature of the furnace 10, and the automatic wafer transfer device is used for transferring the wafers 26 or a cassette into the quartz tube 12 in order to perform the semiconductor process, such as a heating process. After or during the semiconductor process, waste gas is exhausted through the exhaust device 32 from the quartz tube 12. As shown in FIG. 1, the source cabinet 18 supplies the reactant gas, and the air control system 16 controls the quantity of the input reactant gas so that the reactant gas is inputted into the quartz tube 12. Generally, a thermocouple (not shown) is disposed inside the quartz tube 12. The thermocouple is electrically connected to the temperature control system 22 for measuring the inside temperature of the quartz tube 12, while the temperature control system 22 may output the observed temperature data to the control computer 20 so as to determine the temperature of quartz tube 12 is normal or not.

FIG. 2 is a schematic diagram of the heating system of the vertical type furnace 10 shown in FIG. 1. The main heating device of the vertical type furnace 10 is the resistance-type coil heater 14, disposed outside the quartz tube 12. When current passes through the coil 30 of the coil heater 14, electricity is transformed to heat that is conductively transferred to the wall of the quartz tube 12, raising the inside temperature of the quartz tube 12. In order to control the uniformity of the temperature and air distribution inside the quartz tube 12, the coil heater 14 of the vertical type furnace 10 usually has five heating areas, as sown in FIG. 2. The coil 30 of each heating area is electrically connected to the temperature control system 22. The paddle thermocouple 28 can measure the temperature of different heating areas of the quartz tube 12 and transfer the measured data to the temperature control system 22. Then, the temperature control system 22 can raise or lower the power supply of the coil heater 14 according to the detected data for controlling the heating performance of the coil heater 14 in each heating area in the quartz tube 12.

As mentioned above, the temperature control system 22 can only obtain the temperature distribution result of the quartz tube 12 by the paddle thermocouple 28 for controlling the coil heater 14. If the coil 30 of the coil heater 14 is broken, as shown in FIG. 3, the first heating area with the broken coil 30 will be heated abnormally. However, since the vertical type furnace 10 itself does not contain a real-time detection device nor an interlock system for detecting the performance of the coil heater 14, the temperature control system 22 can only find that the temperature of the first heating area is too low and raise the power supply to the coil 30 in the first heating area, for example, raise the power supply to 100%, but will not send any alarm signal or initiate an interlock process. Accordingly, if the coil heater 14 of the vertical type furnace 100 is broken during a thermal oxidation process, the temperature control system 22 can only change the power supply but cannot instantly discover that the coil heater 14 is broken. Under this situation, the heating temperature is not high enough such that the formed thin film on the wafers will be abnormal, resulted in the products have to be scraped.

Furthermore, if the coil heater 14 is broken down when the vertical type furnace 10 is idle, the temperature control system 22 will just change the power supply to control the temperature variation but cannot notice the coil heater 14 is broken. As a result, wafers will be transferred into the broken vertical type furnace 10 before discovering the problem of that the temperature cannot be raised to the predetermined temperature and initiating the temperature timeout alarm. Furthermore, even the temperature timeout alarm is initiated, the semiconductor process carried out in the vertical type furnace 10 has already formed a thin film with defects on the wafers, and therefore those wafers have to be scraped, causing undesirable cost.

Accordingly, it is still an important issue for the semiconductor manufacturer to provide a heating system with a functionality of discovering the breakdown of the equipment instantly in order to avoid defects of products or raising cost resulted from performing processes in a furnace with a broken coil or abnormal heating performance.

### SUMMARY OF THE INVENTION

It is a primary objective of the claimed invention to provide a semiconductor equipment and a breakdown precautionary system and method thereof to solve the above-mentioned problems.

According to the claimed invention, a semiconductor equipment is provided. The semiconductor equipment comprises at least a coil heater and at least a voltage/current detector. The coil heater comprises at least a current input node and a current output node, and the voltage/current detector is capable of detecting the real-time currents and voltages of the current output node and the current output node. When a current detected by the voltage/current detector is 0 ampere (A), the semiconductor equipment will drive an alarm system to send an alarm signal to express that the coil heater may be broken.

According to the claimed invention, a breakdown precautionary system of a semiconductor equipment is further provided. The breakdown precautionary system comprises a semiconductor equipment with a coil heater, at least a voltage/current detector, and an alarm system. The coil heater has at least a current input node and a current output node, and the voltage/current detector detect real-time data of the currents and voltages of the current output node and current output node at the same time. When a current detected by the voltage/current detector is 0 A, the alarm system will send an alarm signal and initiate an interlock safety measure of the semiconductor equipment.

According to the claimed invention, a breakdown precautionary method of a semiconductor equipment is even further provided. The breakdown precautionary method comprises providing a semiconductor equipment comprising a coil heater, detecting the current and voltage of the coil heater to obtain real-time data of the voltage and current, sending an alarm signal when a detected current is 0 A to express that the coil heater may be broken.

It is an advantage of the claimed invention that the method comprises real-time monitoring the current and voltage of the coil heater of the semiconductor equipment for determining whether the coil heater is broken down or not, and therefore the breakdown could be discovered as soon as possible. As a result, the situation of transferring wafers into a broken semiconductor equipment, which causes damages of the wafers, could be avoided. Accordingly, the present invention breakdown precautionary system and method of a semiconductor equipment can lower the process risk and undesirable cost lose with simple devices.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of the structure of a vertical type furnace according to the prior art.

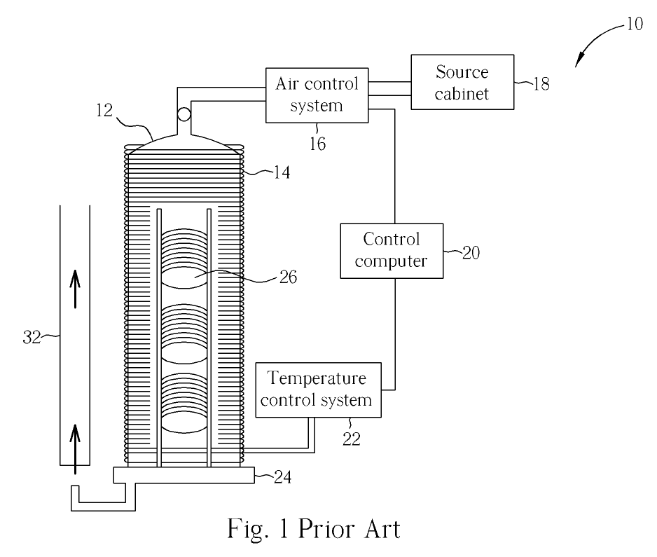

FIG. 2 is a schematic diagram of the heating system of the vertical type furnace shown in FIG. 1.

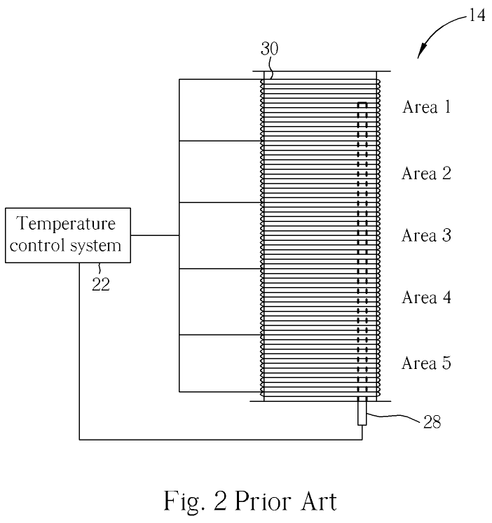

FIG. 3 is a schematic diagram of a broken heating system of the vertical type furnace shown in FIG. 1.

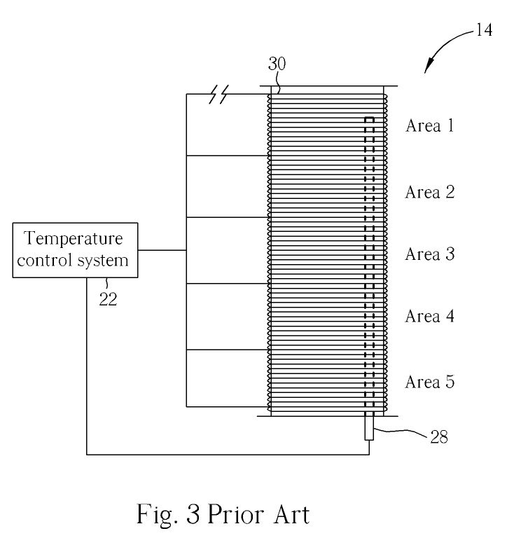

FIG. 4 is a schematic diagram of a semiconductor equipment according to the present invention.

FIG. 5 is a schematic diagram of a breakdown precautionary system of a semiconductor equipment according to a second embodiment of the present invention.

FIG. 6 is a process diagram of a breakdown precautionary method of a semiconductor equipment according to the present invention.

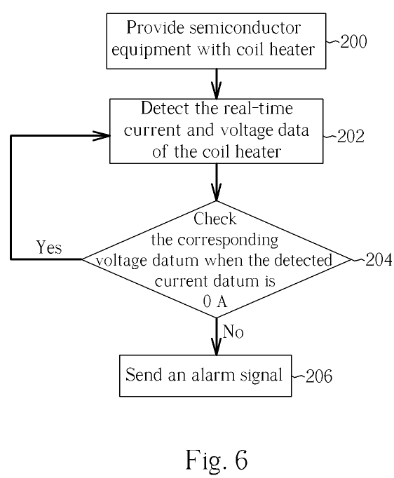

### DETAILED DESCRIPTION

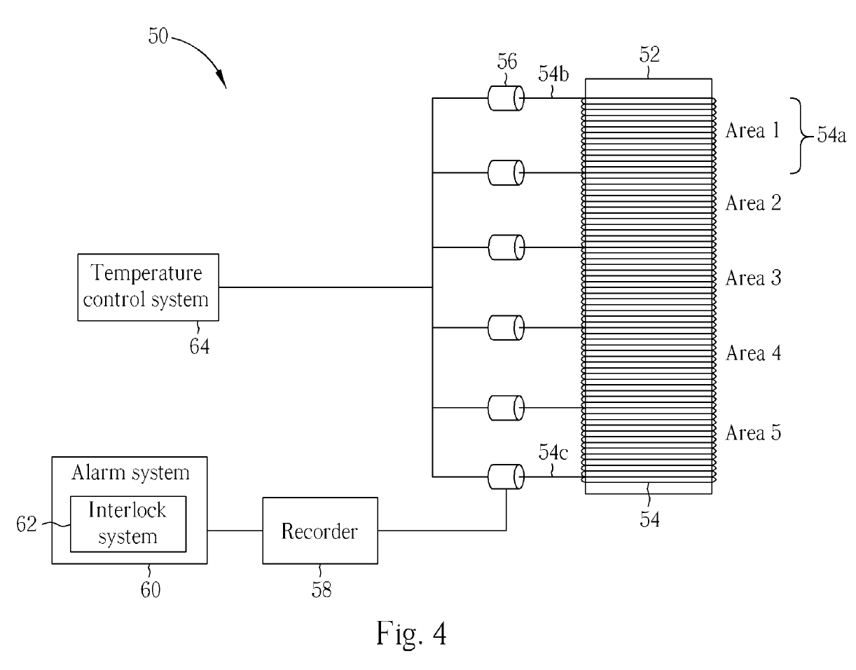

Please refer to FIG. 4, which is a schematic diagram of a semiconductor equipment 50 according to the present invention. The present invention semiconductor equipment 50 comprises a process chamber 52, at least a coil heater 54, at least a voltage/current detector 56 (five voltage/current detectors 56 are shown in FIG. 4), and a temperature control system 64. The present invention semiconductor equipment 50 may be used for heating wafers or providing a chamber with a raised temperature. For example, the process chamber 52 may be a thermal oxidation chamber or a diffusion chamber for performing a thermal oxidation process, a doping process, a drive-in process, or an annealing process. In this embodiment, the process chamber 52 is a vertical type furnace with a quartz tube for example, where wafers or cassettes may be positioned. However, the type of the furnace or the process chamber 52 is not limited herein.

The coil heater 54 is disposed at outside of the process chamber 52, comprising at least a current input node 54b and at least a current output node 54c. When current passes through the current input node 54 of the coil heater 54, the coil heater 54 consumes electricity to transform it into heat, and the produced heat will be transferred conductively to the wall of the process chamber 52 so as to raise the inside temperature of the process chamber 52 to reach the heating objective. Generally, the coil heater 54 comprises five heating areas 54a for controlling the temperature of the vertical type furnace dividedly. The temperature control system 64 is electrically connected to the coil heater 54, and outputs power to the coil heater 54 to control the temperature of each heating area 54a. The voltage/current detectors 56 shown in FIG. 4 may be a plurality of current transformers disposed at the current output node 54c and the current input nodes 54b corresponding to each heating area 54a for detecting the current and voltage of each current input node 54b and current output node 54c. The current transformers detect the current of each heating area 54a through an induction way since currents passing through the current input nodes 54b or current output node 54c occur magnetic fields.

The semiconductor equipment 50 further comprises a recorder 58 and an alarm system 60. The recorder 58 is electrically connected to each voltage/current detector 56 (FIG. 4 only shows one of the voltage/current detectors 56 is electrically connected to the recorder 58 for explanation), and used for recording the data of the current and voltage detected by the voltage/current detectors 56. In various embodiments, the recorder 58 may optionally further comprise a general monitor system (GMS) or a statistic process control (SPC) system (not shown) to make a statistical record of the current or value data for obtaining a reference of updating the equipment. The functionalities of the GMS or SPC system will be further explained in the second embodiment of the present invention.

The alarm system 60 is electrically connected to the recorder 58. When one of the values of the currents detected by the voltage/current detectors 56 is 0 A, the alarm system 60 will send an alarm signal to express that the coil heater 54 may be broken. In other embodiments, a control chip may be disposed in the alarm system 60 or the recorder 58, which is set to check whether the corresponding voltage is 0 V or not when the current of the coil heater 54 detected by the voltage/current detector 56 is 0 A. Then, the alarm system 60 sends the alarm signal only If the corresponding voltage is not 0 V. In addition, the alarm system 60 may further comprise an interlock system 62. While the alarm system 60 sends the alarm signal, the interlock system 62 also initiates an interlock safety measure of the semiconductor equipment 50 at the same time, wherein the interlock safety measure may comprise stopping all the processes or motions of the semiconductor equipment 50 or stopping transferring wafers into the process chamber 52.

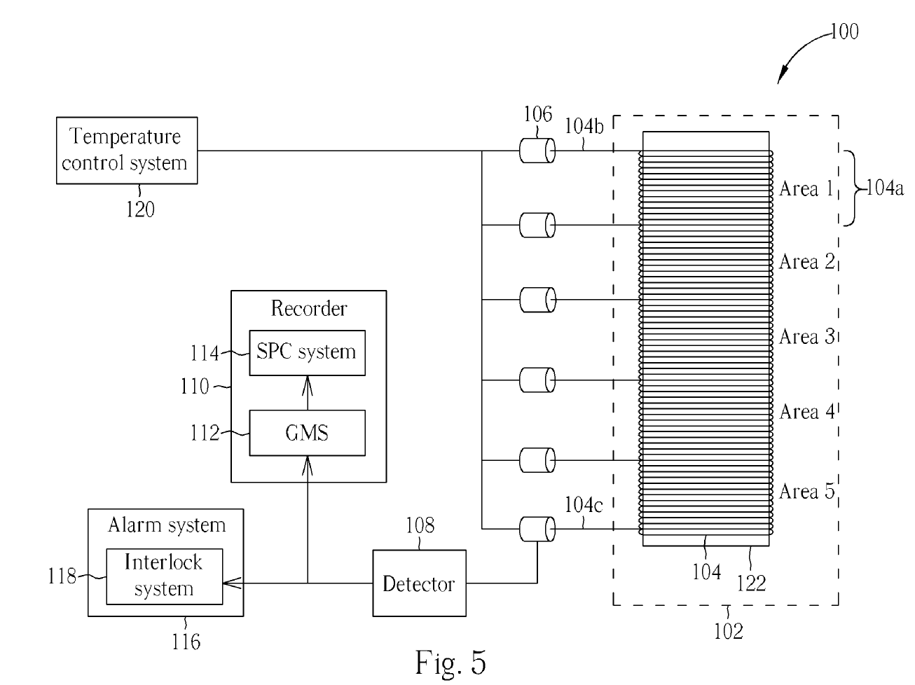

Please refer to FIG. 5, which is a schematic diagram of a breakdown precautionary system 100 of a semiconductor equipment 102 according to a second embodiment of the present invention. The present invention breakdown precautionary system 100 comprises a semiconductor equipment 102, a voltage/current detector 108, a recorder 110, an alarm system 116, and a temperature control system 120. The semiconductor equipment 102 comprises a process chamber 122 and a coil heater 104 positioned surrounding the process chamber 122. The process chamber 122 may be a wet bench, a CVD chamber, or a PVD chamber. According to this embodiment, the coil heater 104 comprises five heating areas 104a, and each heating area 104a has a corresponding current input node 104b. The temperature control system 120 outputs power to the coil heater 104 so as to control the heating temperature of each heating area 104a.

The voltage/current detector 108 comprises a plurality of detection devices, such as the current transformers 106, disposed at each current output node 104c and current input node 104b, for detecting the current and voltage of each heating area 104a and transferring the voltage and current data to the recorder 110 and the alarm system 116. When a datum of the detected current is 0 A, the alarm system 116 will send an alarm signal as a warning for the operator, expressing that the semiconductor equipment 102 may be broken down. At the same time, the interlock system 118 of the alarm system 116 may be set to initiate an interlock safety measure of the semiconductor equipment 102 to stop the fabrication process.

In this embodiment, the recorder 110 comprises a general monitor system 112 and a SPC system 114, wherein the SPC system 114 is used for making a statistical record of the current and voltage data transferred from the voltage/current detector 108, and the general monitor system 112 is capable of connecting with an information device with a human machine interface (HMI), such as a personal computer, to provide a function of real-time monitoring the semiconductor equipment 102. In addition, the general monitor system 112 may transform the voltage and current data to readable information of the SPC system 114 so that the SPC system 114 can utilize the readable information to make a statistical record. In a preferable embodiment, the SPC system 114 can define a current alert range or a voltage alert range according to the statistical record. For example, the SPC system 114 may figure out the lifetime expectancy of the coil heater 104 according to the variation of current and voltage of previous semiconductor equipments 102 under the same power supply so as to define the current alert range or voltage alert range representing that the coil heater 104 has a high probability or risk of breakdown. Accordingly, whether the semiconductor equipment 102 is idle or operated for a fabrication process, the alarm system 116 will send the alarm signal if the voltage or current detected by the voltage/current detector 108 reaches the current alert range or voltage alert range Therefore, the operator can check the semiconductor equipment 102 or retire the semiconductor equipment 102 to avoid the semiconductor equipment 102 breaking during a process to damaging the products. Furthermore, when the voltage or current reaches the current alert range or voltage alert range, the interlock system 118 of the alarm system 116 may initiate the interlock safety measure of the semiconductor equipment 102 to stop the motion of the semiconductor equipment 102.

It should be noted that the current and voltage of the coil heater 104 should be detected continuously by the breakdown precautionary system 100 according to the present invention spirit, whether the coil heater 104 or the semiconductor equipment 102 is idle or performing a process, such that the semiconductor equipment 102 can be monitored at all times to prevent wafers or products from being transferred into the semiconductor equipment 102 while the semiconductor equipment 102 is already broken down, and damages of wafers or products can be avoided.

As a result, the breakdown precautionary method of a semiconductor equipment according to the present invention comprises the steps as following:

Step 200: Provide a semiconductor equipment comprising a coil heater, wherein the coil heater has at least a current input node and a current output node.

Step 202: Detect the real-time current and voltage of the current input node and current output node of the coil heater whether it is idle or not.

Step 204: When a detected current datum is 0 A, check if the corresponding voltage datum is 0 V. If the corresponding voltage is not 0 V, perform Step 206.

Step 206: Send an alarm signal to express that the coil of the coil heater may be broken.

Since the current of the coil heater under a power supply should not be 0 A, it is apparent that the resistance-type coil of the coil heater may be broken if the detected current is 0 A. Therefore, it is easy to discover the breakdown of the coil heater or the semiconductor equipment according to this theory of the present invention as soon as possible.

In contrast to the prior art, the present invention utilizes simple devices such as the voltage/current detector to obtain the real-time current and voltage data of the coil heater to avoid transferring wafers into the semiconductor equipment that is already broken down. In addition, the breakdown precautionary system of the present invention utilizes a SPC system to anticipate the lifetime or breakdown risk of the equipment. Therefore, the old equipments can be retired before they are really broken, preventing undesirable damage of products and cost lose. Furthermore, the present invention semiconductor equipment is not limited with the types mentioned in the above embodiments. For example, the present invention semiconductor equipment may be a vertical type furnace, a horizontal type furnace, or has a process chamber such as a wet bench, a CVD chamber, or a PVD chamber. The present invention can be applied to any semiconductor equipment with a resistance-type coil heater for monitoring the performance of the semiconductor equipment and avoiding undesirable cost caused by the breakdown of the coil heater.

Those skilled in the art will readily observe that numerous modifications and alterations of the device and method may be made while retaining the teachings of the invention.

What is claimed is:

1. A semiconductor equipment, comprising:
at least a coil heater having at least a current input node and a current output node; and
at least a voltage/current detector capable of detecting real-time voltages and currents of the current input node and the current output node;
wherein when a current detected by the voltage/current detector is 0 ampere (A), the semiconductor equipment drives an alarm system to send an alarm signal for expressing that the coil heater may be broken.

2. The semiconductor equipment of claim 1, wherein the voltage/current detector comprises at least a current transformer.

3. The semiconductor equipment of claim 1, wherein the alarm system comprises an interlock system that initiates an interlock safety measure of the semiconductor equipment when the alarm system sends the alarm signal.

4. The semiconductor equipment of claim 1, wherein when the current detected by the voltage/current detector is 0 A, the alarm system will check if a corresponding voltage is 0 volt (V) and send the alarm signal as the corresponding voltage is not 0 V.

5. The semiconductor equipment of claim 1, further comprising a recorder for recording data of the voltages and currents detected by the voltage/current detector.

6. The semiconductor equipment of claim 5, wherein the recorder comprises a general monitor system (GMS).

7. The semiconductor equipment of claim 5, wherein the recorder comprises a statistic process control (SPC) system for making a statistical record of the data of the voltages and currents inputted from the voltage/current detector.

8. The semiconductor equipment of claim 7, wherein the SPC system is capable of defining a current alert range and a voltage alert range according to the statistical record, and the alarm system will send an alarm signal when a current or voltage datum detected by the voltage/current detector reaches the current alert range or the voltage alert range.

9. The semiconductor equipment of claim 8, wherein the alarm system will initiate an interlock safety measure of the semiconductor equipment when the voltage or current detected by the voltage/current detector reaches the current alert range or the voltage alert range.

10. The semiconductor equipment of claim 1, wherein the coil heater comprises a plurality of heating areas and a plurality of current input nodes corresponding to the heating areas, and the semiconductor equipment comprises a plurality of voltage/current detectors for detecting the current of each of the current input nodes.

11. The semiconductor equipment of claim 1, comprising a furnace.

12. The semiconductor equipment of claim 11, wherein the furnace is a vertical type furnace.

13. The semiconductor equipment of claim 1, comprising a thermal oxidation chamber or a diffusion chamber.

14. The semiconductor equipment of claim 1, comprising a wet bench, a chemical vapor deposition (CVD) chamber, or a physical vapor deposition (PVD) chamber.

15. The semiconductor equipment of claim 1, comprising the alarm system.

16. A breakdown precautionary system of a semiconductor equipment, comprising:
a semiconductor equipment comprising a coil heater, the coil heater having at least a current input node and a current output node;
at least a voltage/current detector capable of detecting real-time voltages and currents of the current output node and the current output node at the same time; and
an alarm system that sends an alarm signal and initiates an interlock safety measure of the semiconductor equipment when a current detected by the voltage/current detector is 0 A.

17. The breakdown precautionary system of a semiconductor equipment of claim 16, wherein the voltage/current detector comprises at least a current transformer.

18. The breakdown precautionary system of a semiconductor equipment of claim 16, wherein the alarm system comprises an interlock system used for initiating the interlock safety measure of the semiconductor equipment.

19. The breakdown precautionary system of a semiconductor equipment of claim 16, wherein when the current detected by the voltage/current detector is 0 A, the alarm system will check if a corresponding voltage is 0 V and send the alarm signal as the corresponding voltage is not 0 V.

20. The breakdown precautionary system of a semiconductor equipment of claim 16, further comprising a recorder used for recording data of the currents and voltages detected by the voltage/current detector.

21. The breakdown precautionary system of a semiconductor equipment of claim 20, wherein the recorder comprises a general monitor system.

22. The breakdown precautionary system of a semiconductor equipment of claim 20, wherein the recorder comprises a SPC system used for making a statistical record of the data of the currents and voltages inputted from the voltage/current detector.

23. The breakdown precautionary system of a semiconductor equipment of claim 22, wherein the SPC system is capable of defining a current alert range and a voltage alert range according to the statistical record, and the alarm system will send an alarm signal when a current or voltage datum detected by the voltage/current detector reaches the current alert range or the voltage alert range.

24. The breakdown precautionary system of a semiconductor equipment of claim 23, wherein the alarm system will initiate an interlock safety measure of the semiconductor equipment when the current or voltage datum detected by the voltage/current detector reaches the current alert range or the voltage alert range.

25. The breakdown precautionary system of a semiconductor equipment of claim 16, wherein the coil heater comprises a plurality of heating areas and a plurality of current input nodes corresponding to the heating areas, and the voltage/current detector for detecting the current of each of the current input nodes.

26. The breakdown precautionary system of a semiconductor equipment of claim 16, comprising a furnace.

27. The breakdown precautionary system of a semiconductor equipment of claim 26, wherein the furnace is a vertical type furnace.

28. The breakdown precautionary system of a semiconductor equipment of claim 16, wherein the semiconductor equipment comprises a thermal oxidation chamber or a diffusion chamber.

29. The breakdown precautionary system of a semiconductor equipment of claim 16, wherein the semiconductor equipment comprises a wet bench, a CVD chamber or a PVD chamber.

30. A breakdown precautionary method of a semiconductor equipment, comprising:
providing a semiconductor equipment comprising a coil heater;
detecting a voltage and a current of the coil heater to obtain real-time data of the voltage and current; and
sending an alarm signal for expressing that the coil heater may be broken when the detected current of the coil heater is 0 A.

31. The breakdown precautionary method of a semiconductor equipment of claim 30, further comprising a step of checking if the corresponding voltage is 0 V or not when the detected current of the coil heater is 0 A, and then sending the alarm signal as the corresponding voltage is not 0 V.

32. The breakdown precautionary method of a semiconductor equipment of claim 30, further comprising detecting the real-time voltage and current of the coil heater when the semiconductor equipment is idle.

33. The breakdown precautionary method of a semiconductor equipment of claim 30, further comprising providing at least a voltage/current detector for detecting the real-time current and voltage of the coil heater.

34. The breakdown precautionary method of a semiconductor equipment of claim 33, wherein the voltage/current detector comprises at least a current transformer.

35. The breakdown precautionary method of a semiconductor equipment of claim 30, comprising providing an alarm system for sending the alarm signal.

36. The breakdown precautionary method of a semiconductor equipment of claim 35, further comprising providing an interlock system that will initiate an interlock safety measure of the semiconductor equipment when the alarm system sends the alarm signal.

37. The breakdown precautionary method of a semiconductor equipment of claim 30, further comprising providing a recorder used for recording the real-time data of the voltage and current of the coil heater.

38. The breakdown precautionary method of a semiconductor equipment of claim 37, wherein the recorder comprises a general monitor system.

39. The breakdown precautionary method of a semiconductor equipment of claim 37, wherein the recorder comprises a SPC system used for making a statistical record of the real-time data of the voltage and current of the coil heater.

40. The breakdown precautionary method of a semiconductor equipment of claim 39, wherein the SPC system is capable of defining a current alert range and a voltage alert range according to the statistical record, and the breakdown precautionary method of a semiconductor equipment further comprises sending an alarm system when a datum of the current or voltage detected by the voltage/current detector reaches the current alert range or the voltage alert range.

41. The semiconductor equipment of claim 40, further comprising initiating an interlock safety measure of the semiconductor equipment when a datum of the current or voltage detected by the voltage/current detector reaches the current alert range or the voltage alert range.

42. The breakdown precautionary method of a semiconductor equipment of claim 30, wherein the coil heater comprises a plurality of heating areas and a plurality of current input nodes corresponding to the heating areas, and the breakdown precautionary method of a semiconductor equipment comprises detecting current of each of the current input nodes.

43. The breakdown precautionary method of a semiconductor equipment of claim 30, wherein the semiconductor equipment comprises a thermal oxidation chamber or a diffusion chamber.

44. The breakdown precautionary method of a semiconductor equipment of claim 30, wherein the semiconductor equipment comprises a wet bench, a CVD chamber, or a PVD chamber.
